(19) United States
(12) Patent Application Publication
(10) Pub. No.: US 2023/0022926 A1
(43) Pub. Date: Jan. 26, 2023

(54) DEVICE TO MONITOR AND REDUCE WATER USAGE AND METHOD THEREFOR

(71) Applicant: TIM MEESTER, PARADISE VALLEY, AZ (US)

(72) Inventor: TIM MEESTER, PARADISE VALLEY, AZ (US)

(21) Appl. No.: 17/868,061

(22) Filed: Jul. 19, 2022

Related U.S. Application Data
(60) Provisional application No. 63/223,895, filed on Jul. 20, 2021.

(51) Int. Cl. G01F 1/66; E03B 1/04; G01F 15/063

(52) U.S. Cl. CPC G01F 1/666; E03B 1/04; G01F 15/063

(57) ABSTRACT

A water usage alert device has a housing. An opening is formed through the housing. A water monitoring module is positioned within the housing. The water monitoring module monitors a temperature of water running through a pipe positioned through the opening formed in the housing, an amount of water flowing through the pip; and provides alerts as to a length of time the water has been running through the pipe.

### RELATED APPLICATIONS

This patent application is related to U.S. Provisional Application No. 63/223,8956 filed Jul. 20, 2021, entitled “SHOWER DEVICE TO REDUCE THE AMOUNT OF WATER USED BY A USER SHOWER” in the name of the same inventor, and which is incorporated herein by reference in its entirety. The present patent application claims the benefit under 35 U.S.C § 119(e).

### TECHNICAL FIELD

The present application generally relates to water conservation, and, more specifically to a device and method for monitoring water usage and which provides alerts as to a length of time the water to a device has been running.

### BACKGROUND

Due to climate change, there is a growing need to protect environmental resources. Many federal, state, and local government authorities have imposed stricter water conservation requirements on communities in order to limit the amount of water being used by customers. Water conservation measures can be applied by industry, municipality, and individual users. However, most of these water conservation measures fail to address the issue of educating water consumers on the need to assertively save water.

In both commercial and private settings, the most blatant waste of water, and therefore the areas where conservation will make a significant difference, is in the kitchen and bathroom. People and businesses often have no idea of the amount of water that is wasted on a daily basis while showers or faucets are left running without being monitored. Studies have shown that art individual generally has little awareness of the duration of time spent in a shower and is oblivious to the overall water usage. Five-minute showers can extend to thirty minutes or more when people apply various cosmetics and creams, use dye or other hair treatments, and shave with the water running. According to the Center for Disease Control (CDC), the average person takes a shower for approximately 10 minutes. If the average shower consumes 4 gallons of water per minute, the average person will use 40 gallons of water per shower which equals 14,600 gallons of water per year just for showering. This does not include the average of 12 gallons of water per shower wasted when the water has already risen to the desired temperature but the person taking the shower does not no that it's warm. This waste further does not include the amount of power needed to heat the wasted water and the Co2 emitted to our atmosphere in the process of heating the water.

When the above numbers are applied to larger buildings such as apartment complexes and hotels, the amount of water used yearly takes on enormous proportions. For example, in a 100 room hotel or apartment complex, assuming each room/apartment has a single occupant, and assuming that each room/apartment showers just once a day for 10 minutes, each shower consumes 4 gallons of water a minute equaling 40 gallons per shower, the water usage would be 4,000 gallons. Which is almost 1.5 million gallons of water per year just for a single hotel/apartment complex daily just for showers. Again, this number does not include the 12 gallons of wasted hot water and the energy required to heat the water that then creates the Co2 emitted.

The above numbers in the previous examples only cover shower usage. They don't include water running from commercial faucets, outdoor pool showers, water fountains and features, kitchens, public showers, home and golf course irrigations systems for example. Also, the water usage numbers do not include energy consumption for heating the water in many cases.

Therefore, it would be desirable to provide a device and method that overcomes the above. The device and method would provide alerts to the user to inform the user of the current duration of water usage. The device and method will provide an accounting of the approximate water usage from a device for a predetermined period of time.

### SUMMARY

In accordance with one embodiment, a water usage alert device is disclosed. The water usage alert device has a housing. An opening is formed through the housing. A water monitoring module is positioned within the housing. The water monitoring module monitors a temperature of water running through a pipe positioned through the opening formed in the housing an amount of water flowing through the pipe, and provides alerts as to a length of time the water has been running through the pipe.

In accordance with one embodiment, a water usage alert device is disclosed. The water usage alert device has a housing. An opening is formed through a center of the housing and sized to allow a water pipe to be positioned within the opening. A water monitoring module is positioned within the housing. The water monitoring module monitors a temperature of water running through the water pipe positioned within the opening, an amount of water flowing through the water pipe, and provides alerts as to a length of time the water has been running through the water pipe.

In accordance with one embodiment, a water usage alert device is disclosed. The water usage alert device has a multiple piece housing. An opening is formed through a center of the housing and sized to allow a water pipe to be positioned within the opening. A water monitoring module is positioned within the housing, wherein the water monitoring module monitors a temperature of water running through the water pipe positioned within the opening, an amount of water flowing through the water pipe, and provides alerts as to when the temperature of the water running through the water pipe is at a predefined temperature, a first time alert that the water has been running through the water pipe a first predefined time limit and a second time alert that the water has been running through the water pipe a second predefined time limit.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1A is a perspective view of an exemplary water monitoring device according to one aspect of the present application;

FIG. 1B is an exploded perspective view of the exemplary water monitoring device of FIG. 1 with a top section of one half of the water monitoring device removed according to one aspect of the present application;

FIG. 2 is a perspective view of an exemplary system using the water monitoring device of FIG. 1 with the water monitoring module removed according to one aspect of the present application;

FIG. 3 is a block diagram of an exemplary water monitoring module of the water monitoring device of FIG. 1 according to one aspect of the present application;

FIG. 4 is a perspective view of an exemplary system using the water monitoring device of FIG. 1 according to one aspect of the present application;

FIG. 5 is a block diagram of an exemplary computer of the system depicted in FIG. 4 according to one aspect of the present application;

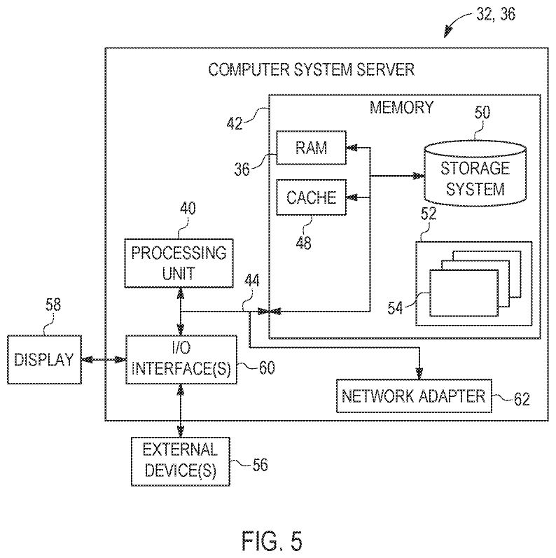

FIG. 6 is an exemplary flowchart showing operation of the water monitoring device of FIG. 1 according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary water monitoring device reduces the amount of water a person will use. The device is designed to reduce the amount of time a user has a valve on a shower, faucet or other water using item open. The device provides alerts as to the amount of time the valve is open and the water is flowing in order to inform the user to shut off the valve. The device also provides information as to the estimated amount of water that was used during the time the valve was open.

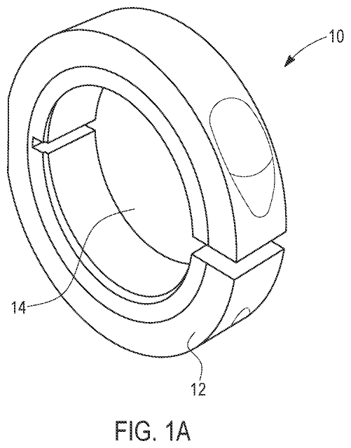

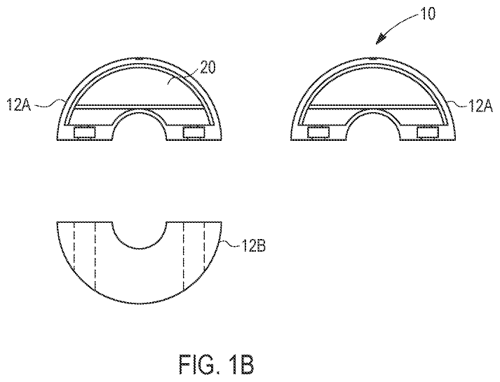

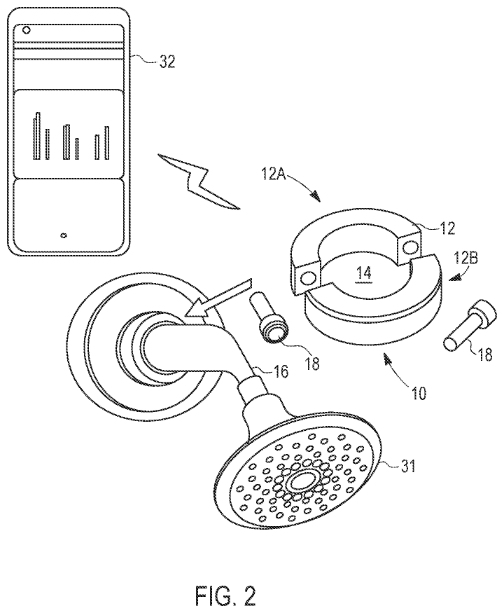

Referring to FIG. 1A-2, a water monitoring device 10 (hereinafter device 10) may be shown. The device 10 may have a housing 12. The housing 12 may be used for storing components of the device 10 as maybe described below. The housing 12 may from an enclosure for storing and protecting the components of the device 10 from water and other elements. In accordance with one embodiment, the housing 12 may be formed of a waterproof/water resistant material.

In the present embodiment, the housing 12 may be formed as a circular enclosure. However, the housing 12 may come in any type of geometrical configurations without departing from the scope of the present invention.

The housing 12 may have an opening 14 formed through a center area of the housing 12. The opening 14 may be sized to allow a water pipe 16 to be positioned therethrough.

In accordance with one embodiment, the housing 12 may be formed of two parts to allow one to place the device 12 around the water pipe 16. As shown in FIG. 2, the housing 12 may be formed of two sections 12A and 12B, The two sections 12A and 12B may be attached together to form the housing 12. A connector 18 may be used to secure the two sections 12A and 12B together. For example, a hinge connector, male/female connectors, locking screw or the like may be used as connectors 18 to secure the two sections 12A and 12B together.

Located within the housing 12 is a water monitoring module 20 (hereinafter module 20). The module 20 may be used to monitor a temperature of the water flowing through the water pipe 16, estimate the amount of water flowing through the water pipe 16 and provide alarms as to time usage and temperature. The above is given as examples. The module 20 may monitor other features without departing from the scope of the present invention.

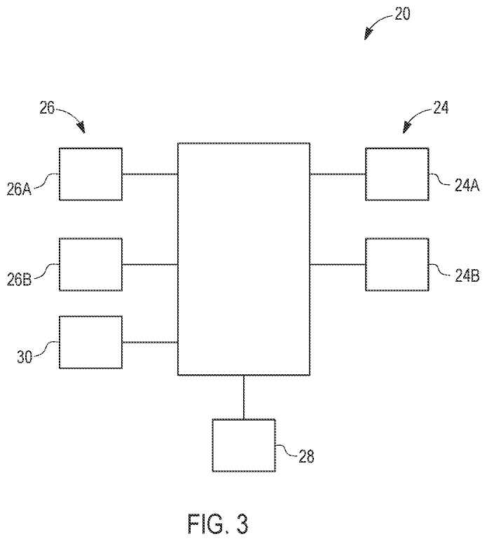

As may be seen in FIG. 3, the module 20 may have a processor 22. One or more sensors 24 may be coupled to the processor 22. In accordance with one embodiment, the module 20 may have at least one temperature sensor 24A and at least one water monitoring sensor 24B coupled to the processor 22. An alarm unit 26 may be coupled to the processor 22. The alarm unit 26 may be used to provide the user of the device 10 an alert as to a predefined situation. The alarm unit 26 may provide an audible alert, a visual alert or both. The alarm unit 26 may be formed of a speaker 26A, lights 26B or similar alerting devices. The module 20 may have a transmitter/receiver 28 coupled to the processor 22. The transmitter/receiver 28 may be used to transfer data to and from the module 20. In accordance with one embodiment, the transmitter/receiver 28 is a wireless transmitter/receiver. The wireless transmitter/receiver 28 may be designed to operate on any desired wireless standard via any type of wireless connection as disclosed below. The module 20 may have a power supply 30. The power supply 30 may be used to power the module 20. The power supply 30 may be coupled to each of the components of the module 20 via conductive traces on the circuit board of the module 20. In accordance with one embodiment, the power supply 30 may be a battery.

As may be seen in FIG. 2, the device 10 may be placed around the water pipe 16 feeding a water using apparatus 31. In the present embodiment, the apparatus 31 is a shower head. However, this is shown as an example and should not be seen in a limiting manner. In the embodiment shown, the two sections 12A and 12B of the housing 12 are attached together via the connector 18 so that the water pipe 16 extends through the opening 14 of the housing 12.

Once installed, the water monitoring sensor 24B may begin to monitor the water pipe 16 to determine when the apparatus 31 is in use. Different types of water monitoring sensors 24B may be used to monitor the waterflow through the water pipe 16. For example, the water monitoring sensor 24B may be a vibration sensor which may estimate the water usage based on the amount and frequency of the vibrations monitored from the water pipe 16. The water monitoring sensor 24B may be an ultrasonic sensor which may estimate the water usage based on high-frequency pulse sound waves emitted by the ultrasonic sensor. The above is given as examples and should not be seen in a limiting manner. Other types of water monitoring sensors 24B may be used without departing from the spirit of the present invention.

Studies have shown that 10% to 20% of all the hot water drawn for showering in a typical single-family home is wasted waiting for hot water to arrive. For a 10-minute shower that may consume 4 gallons of water a minute, anywhere from 4 gallons to (12)8 gallons of water or more is wasted waiting for the shower to warm up. Many people wait until there is a visible indication that the water is warm, i.e., steam from the shower and/or “fog” on the glass walls of the shower or mirrors within the bathroom before entering the shower. This waste even more water as these visual indications generally takes more than a few minutes to occur.

To limit the amount of water wasted, the module 20 may have a temperature sensor 24A. The temperature sensor 24A may monitor the temperature of the water flowing through the water pipe 16 to the apparatus 31. When the temperature of the water reaches a desired level, the alarm unit 26 may provide an audible alert, a visual alert or both to the user that the water is at a desired level. For example, many dermatologists have recommend keeping the temperature in a shower at an average of 98° F. (37° C.) to 101° F. Thus, in accordance with one embodiment, when the temperature of the water reaches 98° F., the alarm unit 26 may provide an alert for the user to get into the shower. By alerting the user to immediately get into the shower, the device 10 may limit the amount of water wasted since the user will immediately know that the water temperature is at a desired level. In accordance with one embodiment, the alarm unit 26 may be a speaker which may provide audible alerts. Alternatively, or in addition to, the alarm unit 26 may be one or more lights which may provide a visual alert.

When the water has reached the desired temperature, the module 20 may be used to provide alerts as to an amount of time the user has been in the shower. For example, the processor 22 may have a timing feature. The processor 22 may send a signal to the alarm unit 26 to provide an audible alert, a visual alert or both to the user that the water has been running for a predetermined timeframe. For example, the processor 22 may send a signal to the alarm unit 26 that once the water temperature has reached the desired temperature level, that the water has been running for “X1” amount of time. The alarm signal is an indication to the user to start to rinse off and to finish the shower. The processor 22 may then send another signal to the alarm unit 26 that the water has been running for “X1+X2” amount of time. This alarm signal may be an indication to the user that the user needs to finish the shower.

In accordance with one embodiment, once the temperature of the water has reached 98° F. (37° C.), the alarm unit 26 may provide an alert for the user to get into the shower. The processor 22 may then send a signal to the alarm unit 26 after the water has been running for 4 minutes of time. This alarm signal is provided to inform the user to start to rinse off and to finish the shower. The processor 22 may then send another alarm signal to the alarm unit 26 that the water has been running for 5 minutes. This second alarm signal is provided to inform the user to finish the shower. The above is given as an example and should not be seen in a limiting manner. Other temperature levels and time limits may be used.

The module 20 may have a transmitter/receiver 28. The transmitter/receiver 28 may be used to transmit and receive data to and from the module 20. Thus, the transmitter/receiver 28 may transmit data monitored and recorded by the module 20 to a wireless device 32 and/or the wireless device 32 may be used to transmit data used to program the module 20.

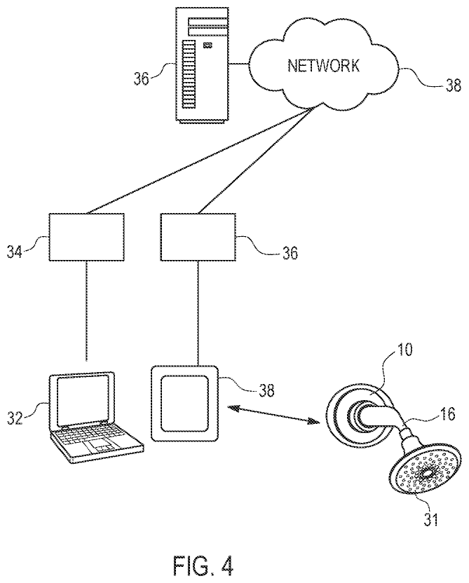

Referring to FIG. 4, the device 10 may communicate with one or more wireless devices 32. The wireless devices 32 may be a client computer system such as a desktop computer, handheld or laptop device, tablet, mobile phone device, server computer system, multiprocessor system, microprocessor-based system, network PCs, and distributed cloud computing environments that include any of the above systems or devices, and the like. The wireless device 32 may be described in the general context of computer system executable instructions, such as program modules, being executed by a computer system as may be described below.

The wireless device 32 may be loaded with an operating system 34. The operating system 34 of the wireless device 32 may manage hardware and software resources of the wireless device 32 and provide common services for computer programs running on the wireless device 32.

The wireless device 32 may be coupled to a computer server 36 (hereinafter server 46). The server 36 may be used to store data files, programs and the like for use by the wireless device 32. The wireless device 32 may be connected to the server 36 through a network 38. The network 38 may be a local area network (LAN), a general wide area network (WAN), wireless local area network (WLAN) and/or a public network.

The server 36 may be used for analysis and storage of data. The server 36 may be any data storage devices/system. In accordance with one embodiment, the server 36 may be cloud data storage. Cloud data storage is a model of data storage in which the digital data is stored in logical pools, the physical storage may span multiple servers (and (often locations), and the physical environment is typically owned and managed by a third-party hosting company. However, as defined above, cloud data storage may be any type of data storage device/system.

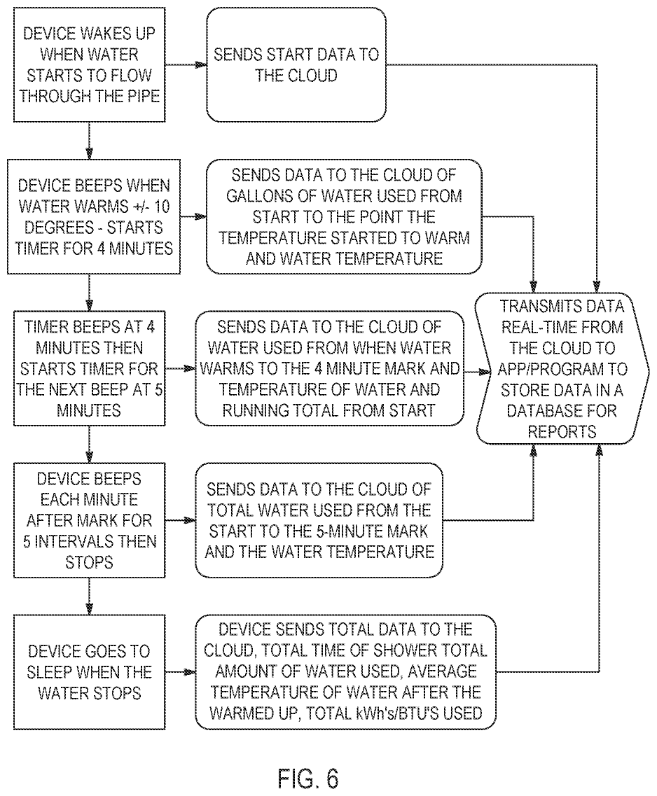

Referring now to FIG. 6, the wireless device 32 and/or servers 36 may be described in more detail in terms of the machine elements that provide functionality to the systems and methods disclosed herein. The components of the wireless device 32 and/or servers 36, may include, but are not limited to, one or more processors or processing units 40, a system memory 42, and a system bus 44 that couples various system components including the system memory 42 to the processor 40. The wireless device 32 and/or servers 36 may typically include a variety of computer system readable media. Such media may be chosen from any available media, including non-transitory, volatile and non-volatile media, removable and non-removable media. The system memory 42 could include one or more personal computing system readable media in the form of volatile memory, such as a random-access memory (RAM) 46 and/or a cache memory 48. By way of example only, a storage system 50 may be provided for reading from and writing to a non-removable, non-volatile magnetic media device typically called a “hard drive”.

The system memory 42 may include at least one program product/utility 52 having a set (e.g., at least one) of program modules 54 that may be configured to carry out the functions of embodiments of the invention. The program modules 54 may include, but is not limited to, an operating system, one or more application programs, other program modules, and program data. Each of the operating systems, one or more application programs, other program modules, and program data or some combination thereof, may include an implementation of a networking environment. The program modules 54 generally carry out the functions and/or methodologies of embodiments of the invention as described herein.

The wireless device 32 and/or servers 36 may communicate with one or more external devices 56 such as a keyboard, a pointing device, a display 58, or any similar devices (e.g., network card, modem, etc.). The display 58 may be a Light Emitting Diode (LED) display, Liquid Crystal Display (LCD) display, Cathode Ray Tube (CRT) display and similar display devices. The external devices 56 may enable the wireless device 32 and/or servers 36 to communicate with other devices. Such communication may occur via Input/Output (I/O) interfaces 60. Alternatively, the wireless device 32 and/or servers 36 may communicate with one or more networks 38 such as a local area network (LAN), a general wide area network (WAN), and/or a public network via a network adapter 62. As depicted, the network adapter 52 may communicate with the other components of the computing device 18 via the bus 34.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 50) may be utilized. In the context of this disclosure, a computer readable storage medium may be any tangible or non-transitory medium that can contain, or store a program (for example, the program product 52) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

In operation, the device 10 may first be paired with the wireless device 32. Paring may establish a wireless connection between the device 10 and the wireless device 32 to allow data to be transferred between the device 10 and the paired wireless device 32. Once paired, the device 10 may be placed around the water pipe 16 feeding a water using apparatus 31. In the embodiment shown, the two sections 12A and 12B of the housing 12 are attached together via the connector 18 so that the water pipe 16 extends through the opening 14 of the housing 12.

The module 20 may be preprogramed so that when the sensors 24 monitor a preprogramed value, the sensors 24 may send a signal to the processor 20 to send a signal to the alarm unit 26. However, the preprogrammed values maybe adjusted by the user. A user having a wireless device 32 with the program module 54 may be used to adjust the programmed values of the module 20 as well as to control one or more features of the device 10. For example, through the program module 54 on the wireless device 32, one may be able to set a desired temperature level of the water when the alarm unit 26 may provide an alert for the user to get into the shower, adjust the time limits when the alarm unit 26 may provide an alert for the user to get out of the shower, and adjust the accuracy of the monitoring sensor 24B by indicting the size of the water pipe 16. The above is given as examples and should not be seen in a limiting manner.

Once installed, the water monitoring sensor 24B may begin to monitor the water pipe 16 to determine when the apparatus 31 is in use. Once the water monitoring sensor 24B monitors water flowing through the water pipe 16, the processor 20 may begin to estimate and record the amount of water being used. The monitored/recorded data may then be sent to the server 36 for storage/analysis.

As stated above, different techniques may be used for estimating and recording the amount of water being used. For example, a typical water pipe 16 for a shower is ¾″. The average water flow for a standard ¾ inch PVC pipe is 2.5 GPM (gallons per minute). Once the water monitoring sensor 24B detects a predetermined vibration level, the processor 20 may begin to estimate and record the amount of water being used based on the average water flow for a standard ¾ inch PVC. However, as stated above, the module 20 may be programmable. Thus, the module 20 may be programmed to adjust for different size water pipes 16. Alternatively, or in additional to, the module 20 may be programmed to provide for different average flow rates based on the vibration level monitored by the water monitoring sensor 24B. Further, as stated above, the water monitoring sensor 24B may be an ultrasonic water sensor.

Once the temperature of the water reaches a desired level as monitored by the temperature sensor 24A, the processor 20 may send a signal to the alarm unit 26 to alert the user to get into the shower. The alarm unit 26 may continue to provide alert messages that the water has been running for a predetermined time. For example, the processor 22 may send a signal to the alarm unit 26 after the water has been running for 4 minutes of time. This may signal the user to start to rinse off and to finish the shower. The processor 22 may then send another signal to the alarm unit 26 that the water has been running for 5 minutes and that the user needs to finish the shower. The above is given as an example and should not be seen in a limiting manner. Other time limits may be used and/or programmed into the module 20. During the time that the water monitoring sensor 24B monitors water flowing through the water pipe 16, the monitored/recorded data may be sent to the server 36 for storage/analysis.

When the water monitoring sensor 24B monitors water flowing through the water pipe 16, the module 20 may go into a power saving mode and/or turn off. The module 20 may send all monitored and/or recorded data to the paired wireless device 32 having the program module 54 which then sends the data to the server 36 for storage/analysis. The wireless device 32 may display the total time the water was running, estimated amount of water used for a predetermined time frames, estimated amount of water saved by limiting the use less than a predetermined timeframe (i.e., taking a shower less than 10 minutes), money saved by limiting water usage including cost for heating the water, and the like. The above is given as an example and should not be seen in a limiting manner.

The device 10 may be for at home use as well as have commercial applications for multi-dwelling buildings such as hotels, dormitories, and the like. In multi-dwelling buildings, instructions may be provided for those that do not wish to use the device 10 or for those who may wish to modify the present values of the device 10. For example, a QR code or similar barcode may be used to provide information to the suer on how to turn off, program or adjust the device 10. The QR code may also be used to download the app for programming the module 20.

In a commercial multi-dwelling building application, data from the modules 20 may be sent to one or more hubs positioned throughout the commercial multi-dwelling building. For example, each floor of the commercial multi-dwelling building may have multiple hubs to gather the data from the modules 20 for that floor. The hubs may then transmit the collect data to the server 36 for analysis. The owner of the commercial multi-dwelling building may then review the analyzed data by downloading the app and/or signing into a website. The device 10 may be used by the owner to monitor, daily, weekly, monthly, year to date, and yearly totals of water used, energy used, energy saved, and the like. The above is given as an example and should not be seen in a limiting manner. Other information may be disclosed without departing from the scope of the invention.

The device 10 may be designed to conserve water usage by changing the user's water habits. The device 10 may be designed to alert the user to excessive water usage by providing notice as to an amount of time the water has been running. The device 10 may be used by individuals, owners of multi-dwelling building, municipalities and the like in order to try and change user's water using habits.

While the device 10 may be described above for use with a shower, the device 10 may be used in other applications. The device 10 may be used in irrigations systems either home or commercial application of golf courses. If a larger amount water greater than normal passes through pipe indicating a leak, like a faulty sprinkler head for example, an alert will instantly be sent to alert the homeowner or maintains person that a water leak has just began detected so it may be quickly shot off to be fixed. On average a simple sprinkler head that malfunctions can waste up to 300 gallons of water in a 15-minute interval. Total yearly savings of wasted water could be billions of wasted water just in the USA alone. Thus, the device 10 may be used in any application that rely on large amounts of water flowing through a pipe.

The foregoing description is illustrative of particular embodiments of the application but is not meant to be a limitation upon the practice thereof. The following claims, including all equivalents thereof, are intended to define the scope of the application.

What is claimed is:

1. A water usage alert device comprising:
a housing;
an opening formed through the housing;
a water monitoring module positioned within the housing, wherein the water monitoring module monitors a temperature of water running through a pipe, the pipe positioned through the opening fooled in the housing, an amount of water flowing through the pipe, and provides alerts as to a length of time the water has been running through the pipe.

2. The water usage alert device of claim 1, wherein the housing is waterproof.

3. The water usage alert device of claim 1, wherein the housing comprises:
a first half;
a second half removably attached to the first half; and
connectors for securing the first half to the second half.

4. The water usage alert device of claim 1, wherein the water monitoring module comprises:
a processor;
a temperature sensor coupled to the processor;
a water monitoring sensor coupled to the processor; and
an alarm coupled to the processor.

5. The water usage alert device of claim 4, wherein the water monitoring module comprises a transmitter/receiver coupled to the processor.

6. The water usage alert device of claim 4, wherein the water monitoring module comprises a transmitter/receiver coupled to the processor receiving data to program the water monitoring module and transmitting data monitored by the water monitoring module.

7. The water usage alert device of claim 4, wherein the water monitoring sensor is a vibration sensor.

8. The water usage alert device of claim 4, wherein the water monitoring sensor is an ultrasonic sensor.

9. A water usage alert device comprising:
a housing;
an opening formed through a center of the housing and sized to allow a water pipe to be positioned within the opening;
a water monitoring module positioned within the housing, wherein the water monitoring module monitors a temperature of water running through the water pipe positioned within the opening, an amount of water flowing through the water pipe, and provides alerts as to a length of time the water has been running through the water pipe.

10. The water usage alert device of claim 9, wherein the housing is waterproof.

11. The water usage alert device of claim 9, wherein the housing comprises:
a first half section;
a second half section removably attached to the first half section; and
connectors for securing the first half section to the second half section and around the water pipe.

12. The water usage alert device of claim 9, wherein the water monitoring module comprises:
a processor;
a temperature sensor coupled to the processor;
a water monitoring sensor coupled to the processor; and
an alarm coupled to the processor.

13. The water usage alert device of claim 12, wherein the water monitoring module comprises a transmitter/receiver coupled to the processor receiving data to program the water monitoring module and transmitting data monitored by the water monitoring module.

14. The water usage alert device of claim 12, wherein the water monitoring sensor is a vibration sensor.

15. The water usage alert device of claim 12, wherein the water monitoring sensor is an ultrasonic sensor.

16. A water usage alert device comprising:
a multiple piece housing;
an opening formed through a center of the housing and sized to allow a water pipe to be positioned within the opening;
a water monitoring module positioned within the housing, wherein the water monitoring module monitors a temperature of water running through the water pipe positioned within the opening, an amount of water flowing through the water pipe, and provides alerts as to when the temperature of the water running through the water pipe is at a predefined temperature, a first time alert that the water has been running through the water pipe a first predefined time limit and a second time alert that the water has been running through the water pipe a second predefined time limit.

17. The water usage alert device of claim 16, wherein the multiple piece housing comprises:
a first half section;
a second half section removably attached to the first half section; and
connectors for securing the first half section to the second half section and around the water pipe.

18. The water usage alert device of claim 16, wherein the water monitoring module comprises:
a processor;
a temperature sensor coupled to the processor;
a water monitoring sensor coupled to the processor;
an alarm coupled to the processor; and
a transmitter/receiver coupled to the processor receiving data to program the water monitoring module and transmitting data monitored by the water monitoring module.

19. The water usage alert device of claim 18, wherein the water monitoring sensor is a vibration sensor.

20. The water usage alert device of claim 18, wherein the water monitoring sensor is an ultrasonic sensor.
